(19) United States
(12) Patent Application Publication
(10) Pub. No.: US 2006/0114343 A1
(43) Pub. Date: Jun. 1, 2006

(54) Programmable reference voltage calibration design

(76) Inventors: Zhihong Zhang, Irvine, CA (US); Jiafu Luo, Irvine, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/000,411

(22) Filed: Dec. 1, 2004

(51) Int. Cl. H04N 5/335; H04N 3/14

(52) U.S. Cl. 348/294

(57) ABSTRACT

An apparatus and method for determining a reference value for an imaging device, having a plurality of photosensitive pixels arranged in rows and columns, and having an active data portion and at least one row of pixels outside the active data portion. The method includes operating the at least one row for a predetermined integration time, applying a first reference value to the pixels in the at least one row, reading out at least one pixel from the at least one row to obtain a first output value, applying a second reference value to the pixels in the at least one row; reading out at least one pixel from the at least one row to obtain a second output value, determining the reference value corresponding to an intended output; and applying the determined reference value to the active data portion of the imaging device.

### FIELD OF THE INVENTION

This invention relates generally to a system and method for improving calibration through determination of a programmable reference voltage. This invention particularly relates to the calibration of an image sensor.

### BACKGROUND OF THE INVENTION

In a typical image sensor, pixels are arranged in rows and columns and each pixel has a read switch that connects the pixel to a vertical line. Horizontal control lines activate the read switches of a row of pixels. The horizontal lines are pulsed in sequence to read the light-dependent pixel voltages onto the vertical lines. A vertical shift register or decoder is commonly used to generate the read pulse sequence. The voltages on the vertical column lines then pass through a set of elements, one per column, which process the pixel output signals. Typical operations performed by the column elements include storage, amplification, buffering, analog-to-digital conversion (ADC) sampling and comparison.

One side effect of the column elements is that the column elements add distortions or noise in the form of offset voltages to the pixel voltages. The offset voltages produced by each column element may vary randomly from one column element to another column element. Substantially, the same offset is applied to each pixel in a given column. This results in vertical shading of the output image, known as column fixed pattern noise (“Column FPN”). Column FPN is simply the difference in the output of two or more functionally identical columns. The main sources of these offsets are mismatches in the charge injection of the sampling switches and amplifier offsets.

Column FPN can be removed by calibrating the image sensor to compensate for the offsets. The sensor is calibrated by applying a reference voltage to the inputs of each column element. The resulting output allows the offset of each column to be measured and stored, typically in registers. The measured offset can subsequently be subtracted from the pixel outputs by analog or digital means. The calibration operation can be performed in a number of ways including once per line or once per field. Each calibration technique has limitations as discussed, for example, in U.S. Patent Publication No. 20020051067 to Henderson. The calibration can be performed once per line, but this calibration reduces the time available for pixel conversion. Calibration can also be performed once per field. However, in a once per field calibration, care must be taken such that random thermal noise does not affect the results and that the calibration is not influenced by effects not present during the pixel readout. Both techniques can also increase the cost or complexity of the sensors.

Other issues could also drive up costs or complexity and generate other problems. The calibration that is conducted on the sensor side can depend on the back end chip. However, it is typically preferable to calibrate the system on the sensor side thereby saving both calibration times and silicon costs that arise when depending on the backend chip to calibrate the system. In addition, in the prior art, the systems associated with the image sensor would need to be pre-calibrated prior to use. This would also slow the system and use of the image sensor causing general delays in the image sensor system. Other issues include the ability to calibrate the global offset, which is the sensor's output when there is not light focused on the sensor. Existence of such a global offset will cause error in the color interpretation and will also cause a picture generated by the image sensor to be too dark or light i.e. “wash-out.”

Another problem with prior art systems has been the ability to determine the appropriate calibrations from a reference voltage to remove the offsets from the voltage level. If the calibrations are incorrect, column FPN could arise, causing errors in the imager that may include a less sharp picture, blooming, and other maladies that result in inadequate system performance. Additionally, if the offsets are not determined correctly, this could affect the calibration of the reference voltage setting and also result in a faulty image.

Thus, there is need for a method and system for an image sensor that is able to handle calibrations for a single frame (or multiple frames in a video mode) that eliminates the need for pre-calibration and that provides accurate and fast calibrations for each frame, that accounts for variable amplifier gains, and that reduces calibration time and silicon complexity and costs. The present invention presents methods and systems to efficiently and reliably calibrate the reference voltage setting and remove the offsets from the voltage level.

### SUMMARY

One embodiment of the present invention is a method for determining a reference value for an imaging device, having a plurality of photosensitive pixels arranged in rows and columns, and having an active data portion and at least one row of pixels outside the active data portion. The method includes operating the at least one row for a predetermined integration time, applying a first reference value to the pixels in the at least one row, reading out at least one pixel from the at least one row to obtain a first output value, applying a second reference value to the pixels in the at least one row; reading out at least one pixel from the at least one row to obtain a second output value, determining the reference value corresponding to an intended output; and applying the determined reference value to the active data portion of the imaging device.

A further embodiment is a method for determining a reference value for an imaging device having a plurality of photosensitive pixels arranged in rows and columns and having an active data portion and at least one row of pixels outside the active data portion and includes the steps of operating the at least one row for a predetermined integration time, establishing a target range, selecting a reference value, applying the reference value to the pixels in the at least one row; reading out at least one pixel from the at least one row to obtain an output value and using the reference value to read out the active data portion of the imaging device.

Another embodiment is an image sensor array that includes a plurality of pixels arranged in rows and columns comprising an active data portion, at least one dark row of pixels outside the active data portion and shielded from a light source, at least one DC offset row of pixels outside the active data portion, capable of being operated for a predetermined integration time, and at least one amplifier, configured to adjust the output of at least one pixel of the active data portion by a reference value determined from the at least one DC offset row.

### BRIEF DESCRIPTION OF THE DRAWINGS

FIG. 1 is schematic layout of an image sensor that can be used in the present invention.

FIG. 2 is a graphical representation of an exemplary ideal relationship between DREF and imager output.

FIG. 3 is a graphical representation of an exemplary real, non-ideal relationship between DREF and imager output such as might exist in a first embodiment of the present invention.

FIG. 4 is a graphical representation of a multiple-step procedure used for the calibration of DREF such as might exist in another embodiment of the present invention.

FIG. 5 is a digital hardware block diagram of an exemplary apparatus for the calibration of DREF as shown in FIG. 4.

### DETAILED DESCRIPTION

Embodiments of the invention provide methods and systems for determining a programmable reference voltage that calibrates a reference voltage and removes the voltage level offsets generated by the pixel columns. The programmable reference voltage may be used in an analog design, as well as a digital design. Different algorithms or methods may be used to efficiently and reliably calibrate the reference voltage that may be applied to compensate for and remove the offsets generated by the pixel columns.

Some embodiments use a first algorithm that is based on obtaining a slope of the line of a programmable reference voltage with an initial value when moving the reference voltage step based on the expected black level generated by the system. The algorithm calibrates the necessary DREF to be applied to the system to remove the offset generated by the imager. As stated below, by using the slope and an initial value, calibration can be accomplished and the reference voltage may be determined for the expected black value.

Other embodiments use a second algorithm that is based on a multiple step approach to reach a target window for the reference voltage. The algorithm may be repeated, halving the reference voltage in relation to the previous step's reference voltage to determine an output. Alternatively, the voltage can be stepped by other fractional amounts like one-third, one-quarter, or other contemplated amounts, including absolute amounts, such as a specific voltage, which may be predetermined. The reference voltage is repeatedly stepped until it approaches the target window controlled by an upper and lower black value. The step function is repeated with the next reference voltage until the black level value enters into the target window and stopping the loop calibration. The examples listed below demonstrate the efficiency and accuracy of the calibration.

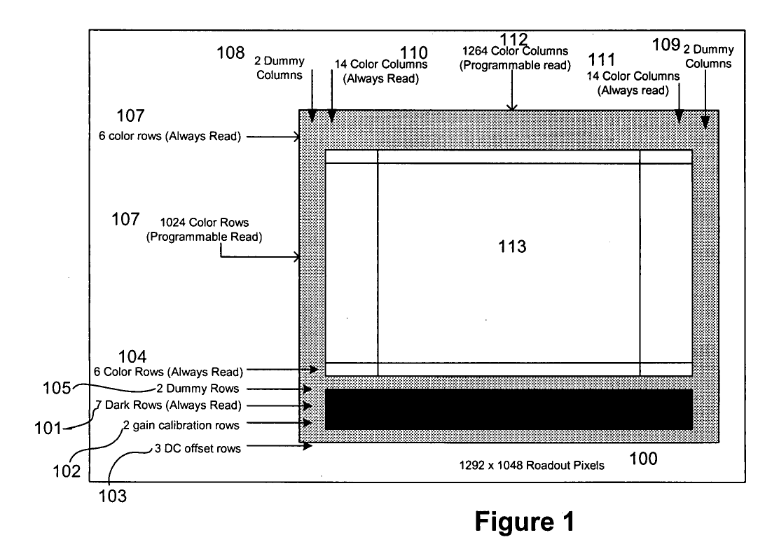

FIG. 1 shows a schematic depiction of the layout of a typical imager (100). In the embodiment, the imager is a typical 1292×1048 readout pixel array. One with ordinary skill in the art understands that the pixel array may be comprised of various numbers of pixels in the columns and row, depending on the needs of the imager (100). The layout of the imager (100) includes at least a shielded dark row (101), a DC calibration row (102) and a gain row (103). The imager can have a variety of combinations of rows for the imager (100) but a preferred embodiment of the invention has the present composition: the shielded dark row (101) comprising seven pixel rows, the DC calibration row (102) comprising three pixel rows, and the gain row (103) comprising two pixel rows. The shielded dark rows (101) are protected from the light source and are used as a reference to aid in the calibration of the image sensor. At the beginning of each frame for the imager, be it a single frame or one frame in a compilation of multiple-frame video, the imager (100) will read the shielded dark rows (101), the DC calibration rows (102) and the gain rows (103). The three DC calibration rows (102) are kept in short (one to two lines) integration in order to calibrate the DC offset, as described below.

As shown in FIG. 1, the imager (100) may have the DC calibration rows (102), shielded gain rows (103) and dark rows (101) situated on the bottom edge of the imager (100) but other configurations are contemplated. The imager (100) can have additional pixel rows including: color rows (104) and a dummy row (105) located substantially near the DC calibration rows (102), shielded gain rows (103) and dark rows (101) in the imager (100). The imager (100) can also have additional pixel rows located substantially away from the DC calibration rows (102), shielded gain rows (103) and dark rows (101) and these pixel rows may include color rows (104), as shown in FIG. 1. A variety of imager configurations are known to those of ordinary skill in the art.

For example, the imager (100) may also have a number of other pixel columns that are often found in imagers. The other pixel columns could include dummy columns (108, 109) and color columns (110, 111). Further, the color columns (110, 111) may always be read by the imager, or programmably read by the imager. The pixel color rows (107) and the pixel color columns (112) form the active pixel array (113) that are used to generate an image in the imager (100) from a source.

In a preferred embodiment, the DREF calibration design is used to calibrate the imager system. However, the calibration designs and methods are applicable to other devices, as is understood by one with ordinary skill in the art.

DREF calibration is used to describe the control of the Digital Analog Converter or “DAC”. In one embodiment, once the DREF calibration is set for a particular imager it is not preferable to change the DREF but a DREF variation can still be contemplated.

The image sensor contemplated in the preferred embodiment could be a CCD, scanner, photocopier, video camera, photoelectric array or any other type of image sensor. The image sensor may be used to capture a single frame or may be used take multiple frames in a video mode. The image sensor may be a variety of sizes or generations, including, for example, 1.3 Meg SXGA or a 300K VGA.

An ideal digital image sensor has no noise and no nonlinearities, so its output is only dependent on the incoming light signal to be imaged. Zero incoming light would produce a zero output. Actual image sensors have a variety of imperfections. In addition to the column FPN mentioned above, the output may be affected by the pixel dark current (a non-zero signal measurable when no light falls on the pixel). The effect of the dark current may be measured by reading out the dark rows (101), which are shielded to receive no light. While in practice there is typically a mismatch between the behavior of the active pixel rows (113) and the shielded rows (101), this can be corrected using a K factor. The K factor typically depends upon the frequency associated with the imager and can vary from 0.2∞2 in normal operation of the preferred embodiment. Furthermore, typical image sensors often use two-channel ADC (analog-to-digital converters)/PGAs (programmable operation amplifiers), which may create additional column FPN.

In addition, imagers generally cannot produce negative outputs because the ADC used to read the signal from the pixels will not go below zero. However, noise variations may cause a pixel signal to be negative. This results in clipping that causes an imager to lose low-light performance, because the array will lose some of the information generated. Clipping may be reduced by having the output corresponding to zero incoming light to be a few counts above zero, instead of precisely zero. With the value above zero, this will prevent a loss of information due to noise fluctuations.

These imperfections may be addressed by an offset adjustment. All of the offsets are given by an equation:
Sum_offset=DREFoffset+K·Dark+column FPNoffset−D_offset.
In this equation, D_offset is the intended average output corresponding to zero incoming light. The Sum_offset is the sum of all offset sources and should be subtracted from the final output value. The preferred embodiment addresses the DREF calibration but other calibration types are contemplated.

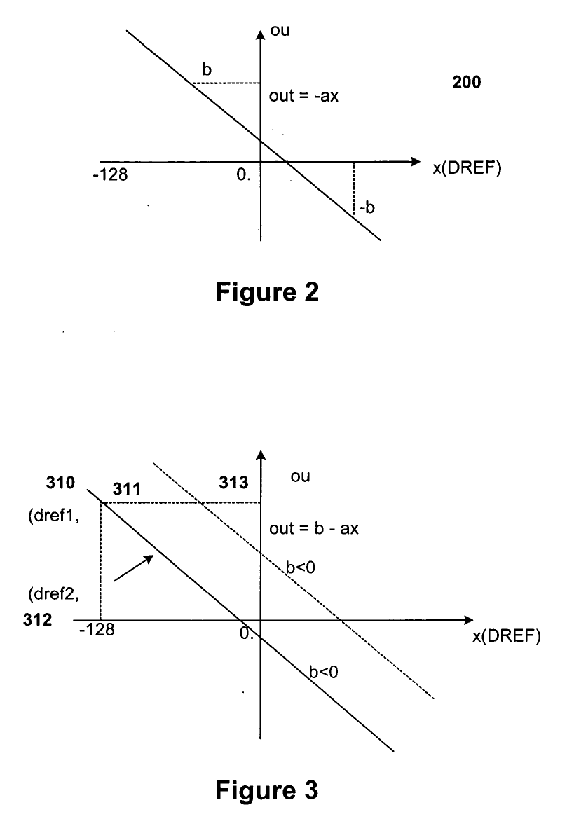

FIGS. 2 through 5, discussed below, are used to describe the principles of the present invention in the patent document and are by way of illustration and should not be construed in any way to limit the scope of the invention. Those skilled in the art will understand that the principles of the present invention may be implemented in any suitable programming manner.

The DREF calibration needed in order to reduce the DC offset down to a certain black level generally depends on the imager gain, which itself may be variable. A calibrated black level allows the system to better use its dynamic range without it being reduced by clipping. Typical imagers are read out using a PGA (programmable gain amplifier), which can be adjusted by the DREF calibration level according to the following formula:
Vₒᵤₜ=(G₁·Vᵢₙ−DREF)G₂
where G₁ and G₂ represent the two-stage gain for the PGA and may be related to the sensor amplifier structure. G₁ and G₂ can vary from sensor-to-sensor. The fundamental mechanics of the two-stage gain is the same for any particular sensor. Vᵢₙ and Vₒᵤₜ are the PGA's input and output voltages. The range of DREF values may vary, depending on the gain. In one example, when G2=0 dB, DREF may vary from −254 DN (−675 mV) to +256 DN (675 mV), and each step corresponds to 2 DN, i.e., 5.3 mV. In another example, when G2=6 dB, the DREF can ideally cover the entire ADC range: −1.35 to 1.35 V (or 0-1023 DN).

FIG. 2 is a graphical representation of the relationship between the value of DREF (in units of DN) and the black level output of an ideal pixel (also in units of DN). In this ideal situation, there is no DC offset, and the video output (200) crosses the axis through the point of the origin (0,0). The black level output may be taken as a function of the DREF and may be shown as a line with the following function:
Out=−ax
where x corresponds to the DREF setting, and a is the slope. The slope may be different depending on imager characteristics and may depend on the gain. For example, a one-unit step change in DREF could cause a change of 2 in the measured output.

However, in most real, non-ideal cases, the line will be shifted due to the DC offset. The line may shift in either the positive or negative direction dependent on the DC offset generated by the imager. FIG. 3 shows an example of the relationship between DREF and the output of a real, non-ideal imager. In this example, the video output is determined by the function:
Out=b−ax,
where b is the data output value or the DC offset generated by the system, and x and a correspond to the same DREF and slope as previously stated. The value b could be either positive or negative, depending on the shift due to the DC offset.

Different methods can be used, within the scope of the present invention, to aid in DREF calibration to determine the necessary reference voltage to reduce the DC offset that is generated. One embodiment of the inventive method is based on determining a slope and initial value of the DREF calibration. Another embodiment is based on a multiple step approach to obtain the calibration, as described below.

In a first embodiment and shown in FIG. 3, the present inventive method obtains the DREF calibration from an initial determination of the values of a and b. Example 1 depicts one example of implementation of this embodiment as follows:

### EXAMPLE 1

C model (case 1 + CAL_RST)
/************************************/
/* Function: DREF_CAL */
/* Maker: David Zhang */
/* Date: 2003.4.10 *1
/***********************************/
#include <stdio.h>
# define DREF_INITIAL −128
# define DREF_STEP 20 //step
# define DREF_OFFSET 20 //DN
# define column 1288 //column
# define row 2 //row
void main ( )
{

int video data[row][colum];
int m;
int dref_adjust;
for (m = 0; m < 20; m++){

Write_Pga (m); //write pga gain from 0 to 19
Dref_Calib (video_data, dref_adjust);
DREF_Map [m] = dref_adjust;

}
exit (0);

}
void Dref_Calib (int *video_data[], int dref_adjust)
{

int m, i, j;
int dref;
int out[8];
int sum_data
for (m = 0; m < 2; m++){

for (i = 0; i < 4; i++){

for (j = 0; j< 322; j++){

if (i = 0 and j =0 ) {

dref = DREF_INTITIAL; //for the first dref=−128
dref_set (dref);

}
else{

if (j = 0){ //dref moves by a step

dref = DREF_INTITIAL + DREF_STEP*(i+m*4);
Dref_Set (dref);

}

}
sum_data = video_data[m][i*322+j];

}
out [m*4 + i] = sum_data;
if (i >0){ //calculate slop and b

a = (out[0] − out[m*4 + i])/( dref − DREF_INTITIAL); //−128 +

step + 128 a>0

b = out[0] + a * dref;
dref_adjust = (b − DREF_OFFSET)/a;

}

}

}

}
void Dref_Set(dref);
int dref
{

write_dref (dref); //write dref value into dref_shad shadow

register
}
void Write_Pga(pga);
int pga;
{

write_pga (pga); //write dref value into dref_shad shadow

register
}

The initial step is to set the DREF value equal to a known, particular digital count value dref, (310). For example, dref, (310) may be set to negative 128, which ensures that the output is above zero and avoids clipping. The output value (out₁) (311) for this DREF setting is measured and stored. Next, the DREF setting is changed to another value dref₂ (312), and the new output value (out₂) (313) is measured again. The value of dref₂ is an arbitrary number, but may also be chosen to avoid clipping. Accordingly, the difference in dref₁ (310) and dref₂ (312) values may be chosen conservatively because a large move along the DREF values might cause data clipping. The two measurements are sufficient to determine the coefficients a and b of the non-ideal equation above. In this example, they may be calculated as follows:

$$a = ( out 1 - out 2 ) / ( dref 2 - dref 1 ) = ( out 1 - out 2 ) / ( 128 + dref 2 ) , \\ b = out 1 + a \cdot dref 1 = out 1 - 128 \cdot a .$$

Once the values for a and b are determined, the relationship between the output and DREF is determined. The relationship allows the sensor to be calibrated so that it has an average non-zero output (D_offset) for zero incoming light, as discussed above. (The optimal D_offset will vary depending on the particular sensor characterization.) The value of DREF for a given D_offset is given by:
DREF=(b−D_offset)/a.
The DREF calibration value may be stored in a shadow register for retrieval and use during imaging.

As discussed above, the DREF relationship is gain-dependent. Therefore, this two-step method may be repeated for each gain setting, and the DREF calibration values stored for each gain setting. The method may also be repeated, even for a particular gain setting, to improve the accuracy of the DREF calibration by averaging out non-ideal effects such as noise.

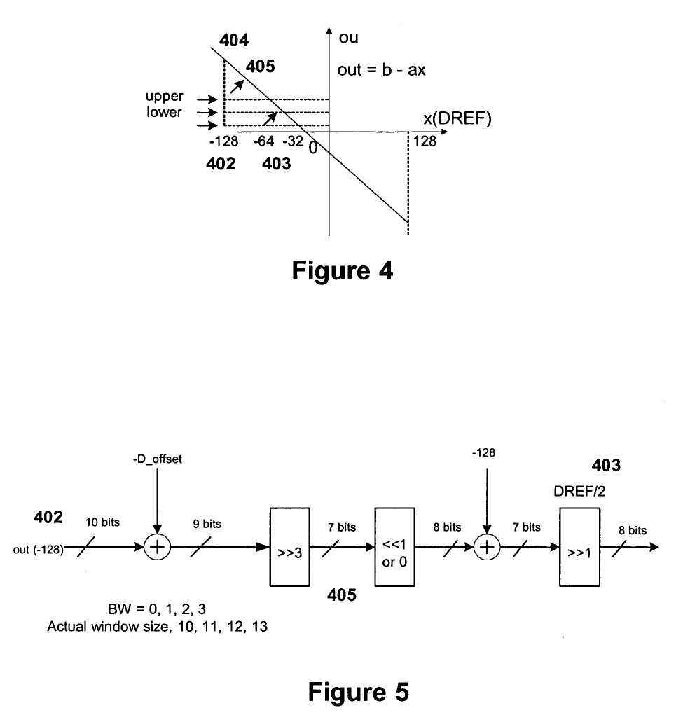

An alternative method uses an iterative algorithm, as illustrated in FIGS. 4 and 5. FIG. 5 is the digital hardware implementation of FIG. 4. Example 2 depicts one example of the implementation of this embodiment as follows:

### EXAMPLE 2

C model (case 2 + CAL_FLY)
/************************************/
/* Function: DREF_CAL */
/* Maker: David Zhang */
/* Date: 2003.4.10 */
/************************************/
#include <stdio.h>
# define DREF_INITIAL −128
# define DREF_STEP 20 //step
# define DREF_OFFSET 20 //DN
# define column 1288 //column
# define row 2 //row
void main ( )
{

int video_data[row][colum];
int m;
int dref_adjust, gain, upper_limit, lower_limit;
if (write_pga(pga) ═ 1) gain_update = 1;
if (gain_update = 1){

Dref_Calib (video_data, dref_adjust, gain);
gain_update = 0;

}
exit (0);

}
int Dref_Calib (int *video_data[], int dref_adjust, int gain, int upper_limit, int lower_limit)
{

int m, i, j;
int dref;
int out[8];
int sum_data;
int DREF_move, slope;
if (gain >= 0 and gain <= 4)

slope = 4;

else

slope = 1;

for (i = 0; i < 8; i++){

for (j = 0; j< 160; j++){

if (i = 0 and j =0) {

dref = DREF_INTITIAL; //for the first dref =−128
dref_set (dref);

}
else{

if (j = 0){ //dref moves by a step

dref = DREF_INTITIAL + DREF_move;
Dref_Set (dref);

}

}
sum_data = video_data[m][i*160+j];

}
out [i] = sum_data
if (out[i] > lower_limit and out[i] < upper_limit)

return (1);

if (i >0) //calculate DREF/2

DREF_move = (−128 + ((out(i) − D_offset)/8).8/slope)/2;

}
return (1);

}
void Dref_Set(dref);
int dref;
{

write_dref (dref); //write dref value into dref_shad shadow

register
}
int Write_Pga(pga);
int pga;
{

write_pga (pga); //write dref value into dref_shad shadow

register

return (1);

}

First, a target window is set (400). The target window has an upper and lower window bound that may be slightly above the expected D_offset (401). Next, the DREF value is set to an initial digital count value dref₁ (402). For example, dref₁ (402) may be set to negative 128, which ensures that the output is above zero and avoids clipping. The black level output value (404) for the dref₁ setting is then measured and checked to see if it is within the target window (400). If it is, this DREF setting is used for the calibration. If it is not, then the next DREF setting, dref₂ (403), is calculated from the current setting and the intended D_offset. For example, the method may step the DREF setting by a fractional (halves, thirds, fourths, eighths, etc.) or a constant amount toward a predicted calibration setting. When stepping by fractional amounts, the step amount is typically calculated using the slope of the DREF-output relationship (405). The slope used in the calculation may be a theoretical or expected value (e.g. 4 DN/step at G₂=0-3 dB and 8 DN/step at G₂=4-7 dB) (405) or may be measured, as described above. An exemplary calculation is as follows. Given a slope a and a first measurement of the black level output for a DREF setting of −128, the expected DREF to produce an average output of D_offset is:
DREFₑ=−128+(out(−128)−D_offset)·1/a
The DREF setting is then stepped by half the difference between the current DREF setting and DREFₑ (i.e. (−128+DREFₑ)/2). The black level output at the new DREF setting is measured, and the algorithm is repeated. Thus the DREF setting is stepped by halves (generating a dref₃, dref₄, etc. as necessary) until the black level output is within the upper and lower bounds of the target window. When the output is within the window, the DREF calibration value has been reached and the algorithm stops. As described above, the DREF value may then be stored for later use. In addition, a series of measurements can be averaged to make the calibration results less sensitive to non-ideal effects.

The DREF calibration may be performed at a variety of times. For example, the calibration may be performed when the imager is first turned on. In this case, the imager may cycle through a series of gain settings, performing the calibration for each one, and store the resulting calibration values in registers for later use, by the imager, back end chip, or even firmware. Alternatively, the calibration may be performed on the fly during the imaging process or each time the gain is changed.

An example of using the DC offset rows to perform an iterative calibration on the fly is as follows. The imager is prepared to capture an image. The gain has already been set (e.g. to 0-3 dB) and the target window is set to 5-10 DN. The DC offset rows are then read out in groups of approximately 80 pixels as follows. The DREF is set to an initial value of −28. The DREF DAC generally will take a certain amount of time to settle after being set, typically about the time it takes to read out 10 pixels. In addition to the DAC, there may also be an analog/digital converter (“ADC”), which typically will cause a further delay, in the amount of a few pixel clock cycles.

For continuity and ease, each group of pixels will have approximately 16 “extra” pixels in addition to those used in the calibration calculations to ensure the DAC settles prior to the next measurement. When the first DC offset row is read out, the output of the first 16 pixels of the first group is discarded. The next 64 pixels are read out and their mean output value calculated. (In this example, the DC offset row pixels are treated in groups of 80 because 80 is a convenient number of pixels in a group because it is the sum of 16 and 64, both easily countable numbers. The number of pixels in a group is arbitrary, however, and one of ordinary skill may choose different groupings to suit any particular application.)

The mean output value is checked to see if it is within the bounds of the target window. If it is not, the expected DREF is calculated from the mean output value, expected slope (e.g. 4 DN/step), and current DREF setting (at first, −128), as described above. Then, the next DREF value is calculated from the expected DREF and the current DREF setting (e.g. the average of the two, thereby stepping the setting by halves). The entire calculation of the next DREF setting is done as DC offset row pixels continue to be read out, although the calculation can be done in as little time as it takes to read out a few or even one more pixels. The DREF is then set to the next value, once calculated.

While the first sixteen pixels of the next group of pixels is read out, the new DREF value is calculated and set, and the DAC is allowed to settle. Then the mean output value of the next 64 pixels is checked to see if it is within the bounds of the target window. If it is, the current DREF is the calibration value. If not, a new DREF value is calculated and the process begins again. The algorithm is repeated until the DREF calibration value is determined.

The calibration is typically performed in only 4 to 6 repetitions of the algorithm. As each repetition takes the time of only reading 80 pixels, the calibration can be performed in the minimal time of reading out 320-480 pixels, while they are being read out. It will be apparent to one of ordinary skill that, because the typical row is typically greater than 600 pixels long, the DREF calibration can be completed in the time it takes to read out a single DC offset row. By adding additional DC offset rows, calibrations can be performed for each frame of a multiple frames in a video mode and account for variable amplifier gains, even when the imager is taking multiple frames in a video mode, as the read out times are substantially short.

In the preceding detailed description of the figures, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical, and electrical changes may be made without departing from the spirit or scope of the invention. Although specific DREF values and steps have been discussed in particular embodiments above, other values and other calibrations may be employed under proper circumstances in implementing the present disclosure.

Furthermore, other embodiments that incorporate the teachings of the invention may be constructed by those skilled in the art. For example, the embodiments discussed above may have a pixel cell connected to a system employing a row and column select access configuration. Other suitable access configurations may be used to read out charge stored by a pixel cell without departing from the spirit and scope of the present disclosure. To avoid detail not necessary to enable those skilled in the art to practice the invention, the description may omit certain information known to those skilled in the art. Accordingly, the present disclosure is not intended to be limited to the specific form set forth herein, but on the contrary, it is intended to cover such alternatives, modifications, and equivalents, as can be reasonably included within the spirit and scope of the invention. In particular, these calibration methods and systems are useful in determining any programmable reference voltage, not only for performing a DREF calibration of an image sensor. The preceding detailed description is, therefore, not to be taken in a limiting sense, and the scope of the present disclosure is defined by the appended claims.

What is claimed:

1. A method for determining a reference value for an imaging device having a plurality of photosensitive pixels arranged in rows and columns and having an active data portion and at least one row of pixels outside the active data portion, said method comprising:
operating the at least one row for a predetermined integration time;
applying a first reference value to the pixels in the at least one row;
reading out at least one pixel from the at least one row to obtain a first output value;
applying a second reference value to the pixels in the at least one row;
reading out at least one pixel from the at least one row to obtain a second output value;
determining the reference value corresponding to an intended output; and
applying the determined reference value to the active data portion of the imaging device.

2. The method according to claim 1 wherein the determined reference value is stored in a memory.

3. The method according to claim 2 wherein the stored reference value is retrieved from the memory in order to apply it to the active data portion.

4. The method according to claim 1 wherein the first output value is the average output of a first group of pixels from the at least one row.

5. The method according to claim 1 wherein the second output value is the average output of a second group of pixels from the at least one row.

6. The method according to claim 1 wherein the integration time of the at least one row is a predetermined time that is shorter than or equal to the integration time of the active data portion.

7. The method according to claim 1 wherein determining the reference value comprises calculating a slope using the first reference value, first output value, second reference value, and second output value.

8. The method according to claim 1 wherein the reference value is determined on the fly.

9. The method according to claim 1 wherein the reference value is determined during an initialization of the imaging device.

10. The method according to claim 1 wherein the reference value is measured in volts.

11. The method according to claim 1 wherein the reference value is measured in digital counts.

12. The method according to claim 1 wherein the intended output is a predetermined value representative of zero input.

13. A method for determining a reference value for an imaging device having a plurality of photosensitive pixels arranged in rows and columns and having an active data portion and at least one row of pixels outside the active data portion, said method comprising:
operating the at least one row for a predetermined integration time;
establishing a target range;
selecting a first reference value;
applying the first reference value to the pixels in the at least one row;
reading out at least one pixel from the at least one row to obtain an output value; and
using the first reference value to read out the active data portion of the imaging device.

14. The method according to claim 13 further comprising determining whether the output value substantially approaches the target range; and wherein the steps of selecting, applying, reading, and determining are repeated until the output value substantially approaches the target range.

15. The method according to claim 14 wherein a current reference value is a predetermined value.

16. The method according to claim 15 wherein selecting a subsequent reference value comprises using the output value to calculate the subsequent reference value.

17. The method according to claim 16 wherein a subsequent reference value is a fractional step from the current reference toward a predicted reference value corresponding to an intended output.

18. The method according to claim 17 wherein the output value is obtained from an average output from a group of pixels in the at least one row.

19. The method according to claim 18 wherein pixels from the at least one row continue to be read out while the subsequent reference value is selected and applied.

20. The method according to claim 19 wherein the groups of pixels used to obtain an average output value are not adjacent.

21. The method according to claim 13 wherein the integration time of the at least one row is a predetermined time that is shorter than or equal to the integration time of the active data portion.

22. An image sensor array, comprising:
a plurality of pixels arranged in rows and columns comprising an active data portion;
at least one dark row of pixels outside the active data portion and shielded from a light source;
at least one DC offset row of pixels outside the active data portion, capable of being operated for a predetermined integration time;
at least one amplifier, configured to adjust the output of at least one pixel of the active data portion by a reference value determined from the at least one DC offset row.

23. The image sensor array of claim 22 wherein the determined reference value corresponds to a predetermined output.

24. The image sensor array of claim 23 wherein the determined reference value is determined by at least two measurements of the output of DC offset row pixels taken at different selected reference values.

25. The image sensor array of claim 24 wherein at least one of the measurements is of the average output of a group of pixels from the at least one DC offset row.

26. The image sensor array of claim 25 wherein the determined reference value is determined by calculating a slope using at least two measurements.

27. The image sensor array of claim 26 wherein the determined reference value is determined by setting a target for the output of DC offset row pixels and iteratively adjusting the reference value until the target is reached.

28. The image sensor array of claim 27 wherein the target comprises a window.

29. The image sensor array of claim 29 wherein the DC offset row pixels continue to be read out while the reference value is adjusted.

30. The image sensor array of claim 22 wherein the determined reference value is stored in a memory.

31. The image sensor array of claim 30 wherein the stored reference value is retrieved from memory.

32. The image sensor array of claim 31 wherein the reference value is determined on the fly.

33. The image sensor array of claim 32 wherein the reference value is determined during an initialization of the imaging device.

34. The image sensor array of claim 33 wherein the reference value is measured in volts.

35. The image sensor array of claim 34 wherein the reference value is measured in digital counts.
